(19) United States
(12) Patent Application Publication
(10) Pub. No.: US 2026/0310407 A1
(43) Pub. Date: Oct. 8, 2026

(54) APPROXIMATE MANTISSA MULTIPLICATION FOR A MULTIPLIER

(71) Applicant: Advanced Micro Devices, Inc., Santa Clara, CA (US)

(72) Inventor: Jian WANG, Shanghai (CN)

(21) Appl. No.: 19/186,289

(22) Filed: Apr. 22, 2025

(30) Foreign Application Priority Data
Apr. 4, 2025 (WO) PCT/CN2025/087373

(51) Int. Cl. G06F 7/487; G06F 17/16

(52) U.S. Cl. CPC G06F 7/4876; G06F 17/16

(57) ABSTRACT

Embodiments herein describe an artificial intelligence (AI) engine including a logic circuit and a multiplier to support mantissa multiplication using approximate mantissa values and logarithmic transformations. The mantissa multiplication is configured to be performed for a floating-point data type such as BF16. Each of the approximate mantissa values is represented having a first part being a leading 1 in a floating point format and a second part being a mantissa field of a floating-point number. The mantissa values are further converted into a logarithmic domain where the mantissa multiplication is transformed to a logarithmic addition operation.

### TECHNICAL FIELD

Examples of the present disclosure generally relate to artificial intelligence (AI) engines, and, in particular, to approximating mantissa multiplication for a multiplier for artificial intelligence (AI) applications.

### BACKGROUND

Data types play a significant role in computing systems, particularly in artificial intelligence (AI) and machine learning (ML) applications, where the choice of data type impacts both precision and efficiency. Commonly used data types, such as integers and floating-point numbers, vary in bit-width and structure, with floating-point formats like FP16, FP8, and bfloat16 gaining prominence for their ability to balance accuracy and resource utilization. The proliferation of data types, however, introduces challenges for hardware architectures, particularly in arithmetic operations like multiplication.

Multipliers, key components in processors and AI engines, perform multiplication operations for specific data types. However, multipliers in AI chips consume significant space and power due to the high number of arithmetic operations for matrix and tensor computations. The large area footprint is driven by the need for multiple parallel multipliers to achieve high throughput. Further techniques are needed to mitigate such issues.

### SUMMARY

One example described herein is an artificial intelligence (AI) engine including a logic circuit and a multiplier configured to support mantissa multiplication using approximate mantissa values and logarithmic transformations.

One example described herein is a method including using, by a multiplier, approximate mantissa values to support mantissa multiplication and applying logarithmic transformations to convert the mantissa multiplication to a logarithmic addition operation.

One example described herein is a processor including one or more artificial intelligence (AI) engines, each AI engine including a multiplier configured to support mantissa multiplication using approximate mantissa values and logarithmic transformations. The processor may be a graphics processing unit (GPU).

### BRIEF DESCRIPTION OF DRAWINGS

So that the manner in which the above recited features can be understood in detail, a more particular description, briefly summarized above, may be had by reference to example implementations, some of which are illustrated in the appended drawings. It is to be noted, however, that the appended drawings illustrate only typical example implementations and are therefore not to be considered limiting of its scope.

FIG. 1A illustrates a brain floating point (BF16) format, according to an example.

FIG. 1B illustrates mantissa multiplication for the BF16 format, according to an example.

FIG. 1C illustrates a multiplier that supports the BF16 format, according to an example.

FIG. 2A illustrates a multiplier that supports mantissa multiplication using approximate mantissa values, according to an example.

FIG. 2B illustrates a method for performing mantissa multiplication using approximate mantissa values, according to an example.

FIG. 2C illustrates a method for converting the exponential format derived from the logarithmic domain to a decimal format, according to an example.

FIG. 2D illustrates a method for using adjust terms to further refine the gate number reduction, according to an example.

FIG. 3 is a block diagram of an accelerator unit (AU) configured to execute workloads for applications running on a processing system, according to an example.

FIG. 4 illustrates a method for implementing a multiplier that supports a mantissa multiplication using approximate mantissa values, according to an example.

To facilitate understanding, identical reference numerals have been used, where possible, to designate identical elements that are common to the figures. It is contemplated that elements of one example may be beneficially incorporated in other examples.

### DETAILED DESCRIPTION

Various features are described hereinafter with reference to the figures. It should be noted that the figures may or may not be drawn to scale and that the elements of similar structures or functions are represented by like reference numerals throughout the figures. It should be noted that the figures are only intended to facilitate the description of the features. They are not intended as an exhaustive description of the examples herein or as a limitation on the scope of the claims. In addition, an illustrated example need not have all the aspects or advantages shown. An aspect or an advantage described in conjunction with a particular example is not necessarily limited to that example and can be practiced in any other examples even if not so illustrated, or if not so explicitly described.

An AI engine is a specialized processing unit used to accelerate artificial intelligence (AI) and machine learning (ML) tasks. AI engines are optimized for the computational requirements of AI workloads, which involve extensive mathematical operations, large datasets, and high parallelism. An AI engine features architectures tailored to handle AI workloads. This may include optimized instruction sets, data paths, and memory hierarchies that facilitate efficient processing of matrix and vector operations found in neural networks. AI engines are used to perform many calculations simultaneously, using data parallelism inherent in AI algorithms.

AI engines include multipliers. A multiplier is a digital circuit or device used to perform multiplication operations on numerical values, usually in binary form. A multiplier is a fundamental component in various computing systems, including processors, digital signal processors (DSPs), graphics processing units (GPUs), and AI accelerators. A multiplier takes two input values (operands) and produces a single output value that is the product of those operands.

Data types define the kind of data that can be stored and manipulated within a computer system. Data types specify the possible values a variable can hold, the operations that can be performed on these values, and the way the values are stored in memory. Different data types play a role in the performance and accuracy of artificial AI/ML models, particularly on specialized hardware like GPUs or AI accelerators. For example, FP32 (32-bit floating-point) is used for training deep learning models because of its high precision. FP16 (16-bit floating-point) is used in AI inference for faster computation with lower memory usage, though with slightly reduced precision.

Floating-Point (FP) data types are used to represent real numbers, including fractions and decimals, in a way that supports a wide range of values. These data types are useful for scientific calculations, graphics, and AI/ML applications where precision and the ability to handle large or small numbers are valuable. Floating-point numbers are stored in scientific notation, represented as a sign (positive or negative), mantissa (or significand), and an exponent. This allows them to cover a wide range of values, from very small to very large. The precision of a floating-point data type refers to how accurately it can represent numbers. Higher precision allows for more significant digits, improving accuracy but also increasing memory usage and computation time.

FP arithmetic is a cornerstone of modern computing, especially in AI and ML workloads, where efficient data representation is valuable. Recently, bfloat16 (BF16) has been proven to be sufficient for AI training in many scenarios, and there are several implementations demonstrating its effectiveness. BF16 is a 16-bit floating-point format with a 7-bit mantissa and an 8-bit exponent, providing a dynamic range similar to 32-bit floating point (FP32) but with reduced precision. This makes BF16 attractive for deep learning (DL) tasks where memory bandwidth and computational efficiency are critical. BF16 reduces memory usage and increases throughput, which is beneficial for large-scale models and datasets. The wide dynamic range of BF16 helps in handling the large variations in values that occur during training, similar to FP32. BF16 integrates into existing hardware and software frameworks, making BF16 a practical choice for many AI applications.

Low-precision AI training has been an active area of research, as it offers the potential for significant improvements in computational efficiency and memory usage. Low-precision AI training is a technique that reduces the bit-width of numerical representations, such as weights and activations, to improve computational efficiency and reduce hardware costs. By using formats like BF16 instead of traditional FP32, low-precision training lowers memory usage, speeds up matrix operations, and decreases power consumption, which is a key factor for large-scale AI models. This approach is adopted in DL accelerators and GPUs, enabling faster training and inference while optimizing resource utilization.

Multipliers are key components in AI accelerators, as they form the backbone of matrix-multiplication-heavy operations like those found in DL workloads. However, their significant area consumption presents a bottleneck in terms of both efficiency and cost. In AI chips, particularly those used for neural network inference and training, matrix multiplication dominates computational workloads. Since multipliers use more silicon area than simpler arithmetic units like adders, their use leads to increased die size, higher power consumption, and ultimately, reduced chip yield and higher manufacturing costs. This issue is pronounced in modern AI workloads, where large-scale DL models demand thousands or even millions of multiplications per inference step.

The primary reason for multipliers'high area consumption lies in their complexity. Unlike adders, which scale relatively linearly with operand size, multipliers use quadratic scaling in transistor count as operand precision increases. For example, a 32-bit floating-point multiplier is significantly larger than an 8-bit integer multiplier due to the additional circuitry needed for exponent handling and normalization. Also, BF16 multiplication still involves significant gate resources, primarily due to the complexity of mantissa multiplication and normalization steps. This results in large die areas, increased power consumption, and reduced overall efficiency, making it challenging to scale AI processors for higher performance. Further, AI architectures often involve massive parallelism to achieve real-time inference and high training throughput, leading to a large number of dedicated multipliers on-chip. As such, the issue of their large footprint remains a challenge.

One effective approach to mitigating the area consumption of multipliers in AI chips is optimizing the mantissa multiplication in the BF16 (bfloat16) format. The BF16 format, used in AI workloads, offers a compromise between precision and computational efficiency by reducing the number of bits used for the mantissa while retaining the same exponent range as FP32. By reducing the complexity of the mantissa multiplication, chip designers can build more efficient AI accelerators with lower power requirements and higher computational density. The example approach employs approximate mantissa multiplication using logarithmic transformations and simple arithmetic operations. Instead of directly performing high-precision floating-point multiplication, the mantissas of the operands are transformed into a logarithmic domain, where multiplication is reduced to addition. Afterward, the result is converted back to the linear domain using a simple exponentiation approximation. This technique significantly reduces the complexity of the computation, allowing for smaller, faster, and more power-efficient hardware implementations. By replacing full mantissa multipliers with lightweight logarithmic approximations, AI hardware designers can achieve comparable levels of computational accuracy while reducing gate count and area usage. Since addition is inherently faster and consumes fewer transistors than multiplication, this method leads to substantial improvements in chip efficiency, energy savings, and computational throughput. Additionally, it allows for higher parallelism, as more operations can be packed into the same silicon area, increasing overall AI processing capability.

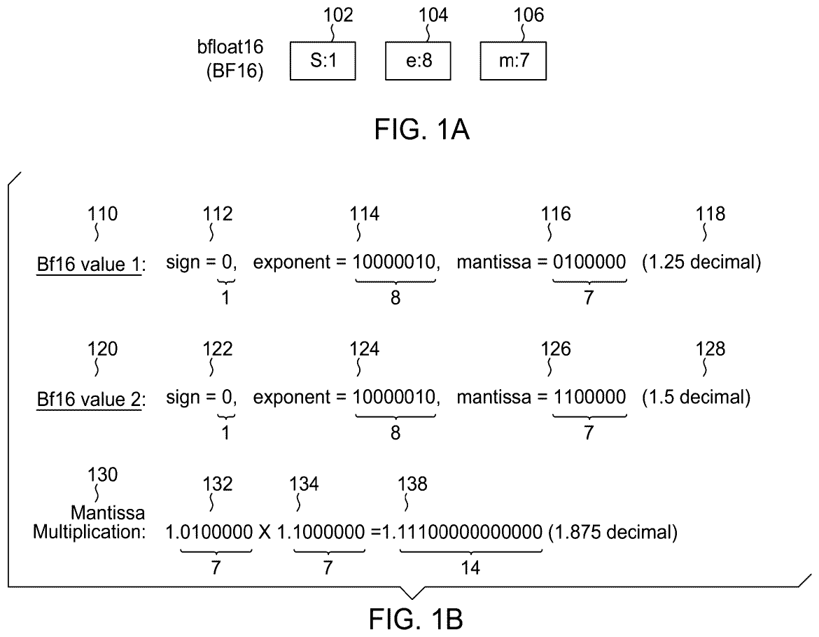

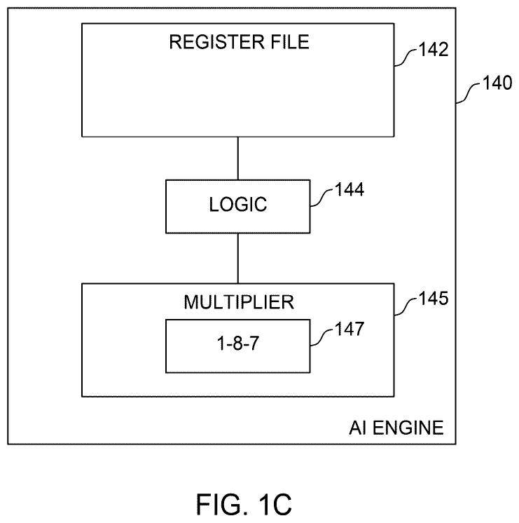

FIG. 1A illustrates a brain floating point (BF16) format, according to an example.

BF16 is a data type used for AI applications. In floating-point formats such as BF16, numbers are represented with a sign, exponent, and mantissa. Multiplication of two floating-point numbers involves multiplying the mantissas and adding the exponents, with the mantissa multiplication being the most resource-heavy part.

As such, bfloat 16 or BF16 includes 1 sign bit 102, eight exponent bits 104 and 7 mantissa bits 106. The sign is designated as (S:1), the exponent is designated as (E:8), and the mantissa is designated as (M:7). BF16 consumes half the storage compared to FP32, which is valuable for AI workloads that involve large datasets and models. BF16 offers a good balance between precision and computation cost.

FIG. 1B illustrates mantissa multiplication for the BF16 format, according to an example.

In a conventional configuration, a BF16 mantissa multiplier performs a multiplication operation using only the 7-bit mantissa portion of two BF16 numbers, essentially calculating the product of their fractional parts while ignoring the exponent, resulting in a less precise calculation but with significantly faster processing speeds compared to full 32-bit multiplication. For example, multiplying the BF16 values representing “1.01” and “1.10” (binary mantissas) would only consider the “01 and “10” parts, producing a result like “1.10” (binary), which would then be adjusted based on the combined exponent.

In an example, the BF16 value 1 (110) may be: 0 10000010 0100000, where the sign=0 (112), the exponent=10000010 (114), and the mantissa=0100000 (116), which roughly translates to 1.25 in decimal (118).

The BF16 value 2 (120) may be: 0 10000010 1100000, where the sign=0 (122), the exponent=10000010 (124), the mantissa=1000000 (126), which roughly translates to 1.5 in decimal (128).

The mantissa multiplication (130) can be: 1.0100000 (132) (from value 1) and 1.1000000 (134) (from value 2)=1.11100000000000 (binary), which roughly translates to 1.875 in decimal (138).

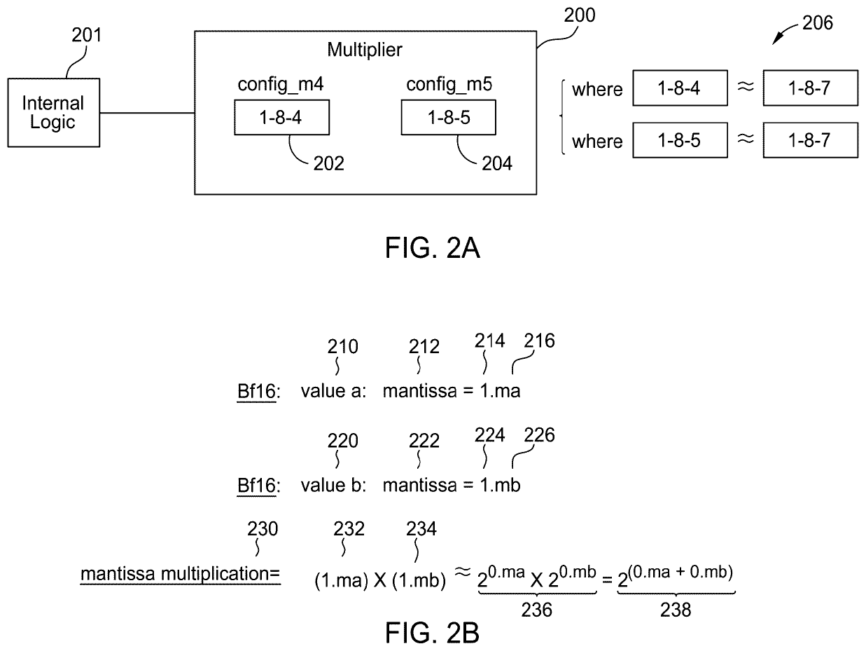

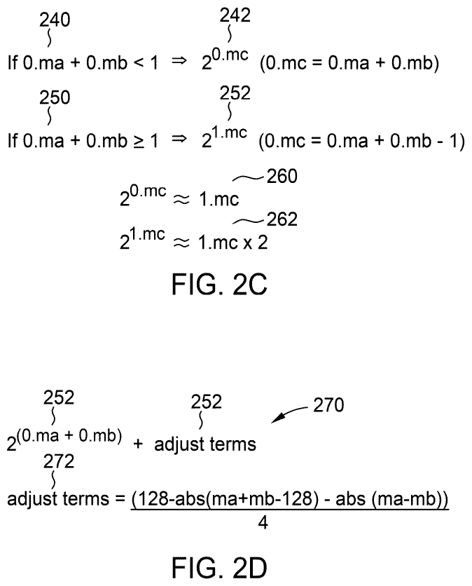

This multiplication involves a full-width multiplication, which increases hardware area and power consumption. A full 7-bit×7-bit (BF16) multiplier involves the use of a significant number of logic gates. Large multipliers consume substantial dynamic power is AI accelerators. Further, the multiplication process introduces delays, limiting throughput. FIGS. 2A-2D below present optimization approaches employing mantissa approximation and logarithmic transformations that help resolve such issues presented by the full-width multiplication of FIG. 1B.

FIG. 1C illustrates a multiplier that supports the BF16 format, according to an example.

The AI engine 140 includes a register file 142 for storing intermediate data, operands, and results during computation. The internal logic 144 can handle mantissa approximations and logarithmic transformations so that multiplications can be performed by the multiplier 145. The multiplier 145 can handle the BF16. For example the multiplier 145 handles the 1-8-7 format (147) of the BF16.

The register file 142 in the AI engine 140 is a small, high-speed storage area that holds a set of registers used for temporarily storing data during computation. The register file 142 stores intermediate values and operands that are actively used during computations, allowing for quick access by the processing units. The register file 142 can accommodate various data types (e.g., integers, floating-point numbers, fixed-point representations) used in AI computations. Many AI engines support mixed precision to optimize performance and resource utilization.

The internal logic 144 operates at a single precision level, avoiding format-specific multipliers. Smaller formats can be accommodated by expanding the inputs and approximating the outputs.

The AI engine 140 is a processing unit of a hardware subsystem used to perform AI computations. The AI engine 140 is optimized for tasks such as ML, DL, and neural network operations, including inference and training. The AI engine 140 may be housed within an AI chip. The AI chip may be referred to as an integrated circuit (IC). The AI engine 140 is the functional component for executing AI algorithms, whereas the AI chip is the physical hardware that includes one or more AI engines.

FIG. 2A illustrates a multiplier that supports mantissa multiplication using approximate mantissa values, according to an example.

The multiplier 200 according to the examples is part of an AI engine (e.g., the AI engine 140) and can handle mantissa multiplication using approximate mantissa values. The multiplier 200 can handle a 1-8-4 format approximation 202 and a 1-8-5 format approximation 204.

AI hardware often uses high-throughput multiplications while optimizing for area, power, and latency. Since AI workloads can tolerate small numerical errors, approximate mantissa multiplication is an effective approach to reduce hardware complexity while maintaining acceptable accuracy. Instead of performing full-precision mantissa multiplication (e.g., 1-8-7 in BF16), the hardware can use a logarithm to convert multiplication to addition. By using logarithmic transformations, see FIGS. 2B and 2C below, the multiplier 200 can convert mantissa multiplication into addition operations.

The internal logic 201 (or logic circuit) of the multiplier 200 can handle multiplications involving mantissa approximation and can also handle logarithmic transformations. Instead of performing full-precision multiplication, the internal logic 201 can approximate the mantissa using reduced precision multiplication. Instead of multiplying full mantissas, an approximated version is used. By using logarithm approximation, gate count and power usage can be reduced. Since multiplication can be transformed into addition in log space, AI hardware can use logarithmic properties.

Multipliers are fundamental in AI and computing. Multiplication is a fundamental operation in many computational tasks, such as convolution, matrix operations, and polynomial evaluations. In AI and ML, multipliers are heavily used for matrix-matrix and matrix-vector multiplications in tasks like neural network training and inference. Hardware multipliers are orders of magnitude faster and more energy-efficient than performing multiplication in software using basic arithmetic operations. Multipliers are used in multiply-accumulate (MAC) units, which are valuable for performing tensor operations in AI workloads. As such, a multiplier is an indispensable building block in digital systems and AI engines, enabling fast and efficient arithmetic operations. Multiplier design and implementation significantly influences the performance, power efficiency, and versatility of modern processors and AI accelerators (e.g., GPUs). Thus, providing the multiplier 200 including mantissa approximation and logarithmic transformation capabilities is advantageous in reducing hardware complexity, providing area savings, lowering power consumption for AI workloads, enabling higher throughput and faster computation, and providing for improved memory bandwidth efficiency.

Traditional floating-point multipliers use large gate counts due to full-precision mantissa multiplication. Approximate mantissa multiplication reduces the number of logic gates by approximating the mantissa values. Logarithmic transformations replace multiplication with addition, further reducing circuit complexity. This allows smaller and more power-efficient AI chips, enabling higher compute density in the same silicon area.

Multiplication is one of the most power-hungry operations in AI accelerators and GPUs. Approximate multipliers reduce dynamic power consumption by lowering switching activity and gate usage. Logarithmic transformations replace costly multiplication circuits with adders, which consume less power.

GPUs and AI accelerators rely on massively parallel matrix multiplications (e.g., general matrix multiplication (GEMM) operations). Approximate multipliers reduce path delay, allowing higher clock frequencies and more operations per cycle. Logarithmic-based multipliers simplify mantissa multiplication to addition, reducing cycle latency.

Therefore, using the multiplier 200 that incorporates mantissa approximations and logarithmic transformations is beneficial for AI accelerators and GPUs. The multiplier 200 reduces hardware area, lowers power consumption, increases throughput, improves memory efficiency, and is well-suited for error-tolerant AI applications.

FIG. 2B illustrates a method for performing mantissa multiplication using approximate mantissa values, according to an example.

The first value, or value a (210) can include a mantissa 212 represented as 1.ma. The first part 214 is the implicit leading 1 in the floating point definition and the second part 216 represents the mantissa field of the floating-point number. The second value, or value a (220) can include a mantissa 222 represented as 1.mb. The first part 224 is the implicit leading 1 in the floating point definition (or floating-point format) and the second part 226 represents the mantissa field of the floating-point number. The floating-point definition refers to the standardized way of representing real numbers (i.e., numbers that can have fractional parts) in a binary format. The term floating-point comes from the fact that the decimal (or binary) point can float or move, based on the exponent.

The mantissa field (or significand) of a floating-point number is the part that includes the significant digits of the number. The mantissa field determines the precision of the floating-point representation. A larger mantissa allows for more significant digits, leading to higher precision in calculations. However, increasing the size of the mantissa field also increases the size of the number, leading to higher memory and processing requirements.

The implicit leading 1 (the first part 214 or the first part 224) is used in normalized floating-point representations, where the leading bit of the mantissa (or significand) is assumed to be 1 and is not explicitly stored in memory. This is an optimization that allows floating-point numbers to use fewer bits while still maintaining the same precision for the significant part of the number. This assumption of an implicit leading 1 works because, in a normalized floating-point number, the value of the mantissa is between 1 and 2 (i.e., it has a leading 1 followed by a fractional part). The leading 1 is not stored, saving 1 bit and allowing the hardware to use this bit for other parts of the representation, such as the exponent or the sign.

By assuming the leading 1 as the first part of the mantissa representation, floating-point formats can achieve greater precision for a given number of bits, since the storage space is used more efficiently. This allows the representation of floating-point numbers with less memory, which is beneficial for storage and computational efficiency, e.g., in hardware like GPUs and AI accelerators.

Therefore, in the floating-point representation, the mantissa (or significand) is stored in the form 1.m, where the first part 214 (or the first part 224) is a 1, which is the implicit leading 1, which is always present in normalized floating-point numbers. The second part 216 (or the second part 226) is represented as m and is the mantissa field, which is the explicitly stored part. The range of the mantissa field (m) is as follows:

The smallest value of m is 0000000(b), meaning the mantissa is 1.0000000(b), which is just 1 in decimal. The largest value of m is 1111111(b), meaning the mantissa is close to 2 in decimal. As noted above, the value of the mantissa is between 1 and 2.

As such, 1.1000000 is the binary fix-point actual mantissa, its decimal format is 1.5 and 0.1000000 is the binary fix-point mantissa only field, its decimal format is 0.5. The mantissa 1.m can be represented in the log space. For example, 1.m, can be represented as 2^{(0.m)}. The difference between 1.m and 2^{(0.m)} is very small if the 0.m range is from 0.0-1.0, which is exactly the range of the mantissa field of a floating-point number. Therefore, 1m can be written as 2^{(0.m)} in a logarithmic representation, as this would be an acceptable approximation of 1m. This converts the multiply operation to an addition operation using logarithmic transformation.

Multiplication of two numbers can be rewritten in logarithmic form as:

$$aXb = {2}^{( {log}_{2} a + {log}_{2} b )}$$

Thus, instead of performing direct binary multiplication, the mantissa values can be converted into a logarithmic domain, where multiplication simplifies to addition. Instead of directly performing a full-precision floating-point multiplication, the multiplication can be approximated using the following steps.

A logarithm approximation can be performed by converting the mantissa of each BF16 number into an approximate logarithmic representation. Addition instead of multiplication can then be used. Since log₂(a×b)=log₂a+log₂b, the multiplication can be replaced with addition, which is far more hardware-efficient. Then, exponentiation approximation is performed by converting the sum back to linear space using a low-complexity exponential approximation.

Stated differently, instead of directly computing the product, the method first approximates the logarithm of the mantissas, performs a simple addition, and then uses an approximate exponentiation function to recover or obtain the approximated result. This eliminates the need for a large floating-point multiplier. Since addition is significantly cheaper in hardware than multiplication, this approach reduces the number of transistors used per operation. As such, by avoiding full floating-point multiplication and relying on simple logarithm addition and exponentiation, the number of transistors used for computation is significantly reduced. Traditional floating-point multipliers involve multiple pipeline stages, large multipliers, and normalization circuits. In contrast, a log-based multiplier replaces multiplication with simple addition, using fewer transistors.

Thus, the mantissa multiplication 230 is given as (1.ma) (232) multiplied by (1.mb) (234), which can be approximated to 2^{(0.ma)}×2^{(0.mb)} (236). As such, the first mantissa (1.ma) and the second mantissa (1.mb) are approximated into the format of 236. This representation can be rewritten in the format 238: 2^{(0.ma+0.mb)}. This multiplication can be referred to as a config_m4 implementation that results in the 1-8-4 BF16 equivalent format. The approximated result is in an exponential format. However, this can be converted into a decimal format.

FIG. 2C illustrates a method for converting the exponential format derived from the logarithmic domain to a decimal format, according to an example.

The approximated result 2^{(0.ma+0.mb)} can be written in two formats.

In a first format 240, if 0.ma+0.mb<1, then the approximation can be written as 2^{0.mc} (242), where 0.mc=0.ma+0.mb.

In a second format 250, if 0.ma+0.mb≥1, then the approximation can be written as 2^{1.mc} (252), where 0.mc=0.ma+0.mb−1.

The exponential format results can be converted to decimal format results.

That is, 2^{0.mc}≈1.mc (260) and 2^{1.mc}≈1.mc X2 (262).

A floating-point format like BF16 has an 8-bit exponent and a 7-bit mantissa. However, an approximate representation like 1-8-4 or 1-8-5 (reducing the number of stored mantissa bits) can help reduce hardware costs while maintaining sufficient accuracy. By approximating the mantissa multiplication using logarithmic transformations, multiplication can be replaced by addition, significantly reducing gate count and power consumption. For example, instead of directly multiplying two numbers, the operation may involve taking the logarithm, performing addition, and then exponentiating the result, which involves simpler hardware. In AI hardware, where multiplication is a bottleneck applying logarithmic approximations can lead to significant reductions in chip area and power consumption without drastically affecting performance. These optimizations are beneficial for building efficient, scalable AI accelerators and GPUs.

In a practical application, the register transfer level (RTL) implementation of config_m4 (using 1.ma*1.mb approximation) has about 42 gates. The original implementation (without approximations) has about 722 gates. The gate number reduction is thus 94% when using approximate mantissa values.

Therefore, the BF16 format uses a 7-bit mantissa, but in many AI workloads, full precision is not always necessary. Approximating the lower-order bits of the mantissa can reduce the multiplier's complexity while maintaining sufficient accuracy. For example, instead of performing full 7-bit mantissa multiplication, a 4-bit approximated multiplier can be used, by estimating them using simple logic operations. This reduces the transistor count of the multiplier while maintaining reasonable accuracy for DL inference. Moreover, one benefits of using logarithmic approximations is the substantial reduction in hardware gate count. A standard floating-point multiplier includes multiple stages, including bit-wise shifts, multiplications, normalizations, and rounding operations, all of which use large silicon resources. By contrast, a logarithmic-based multiplier replaces these steps with simple additions, and lightweight exponentiation circuits, dramatically reducing the number of logic gates used per operation. This efficiency gain translates to higher computational density, meaning that AI accelerators can fit more processing elements (PEs) within the same silicon area, leading to greater parallelism and improved throughput. For instance, an AI chip implementing this technique may allocate more space to matrix operations or memory bandwidth, optimizing the overall balance of resources in AI architectures.

FIG. 2D illustrates a method for using adjust terms to further refine the gate number reduction, according to an example.

In another implementation, referred to as config_m5 (using 1.ma*1.mb approximation), adjust terms can be used depending on the absolute error. The absolute error refers to the difference between the exact result of the multiplication and the approximated result due to use of simplified arithmetic operations. The absolute error quantifies the deviation introduced by the approximation techniques, that is, mantissa approximation and logarithmic transformation.

For example, if two BF16 numbers are considered and represented as 1-8-7, the mantissa multiplication can be approximated to 1-8-4, effectively discarding 3 bits. This introduces a small rounding error, leading to a difference between the exact and the approximated result. If the exact product of the two BF16 numbers is 1.2345×10² and the approximation yields 1.231×10², then the absolute error is the difference, which is 0.35.

Two observations were made regarding the absolute error. First, the max error aligns with the function ma+mb=128, and the error has a positive correlation to abs(ma−mb). Based on these two observations, there is some room to improve the precision with small area overhead. This improvement can be made by using adjust terms after the 2^{(0.ma+0.mb)}.

The first observation suggests that the absolute error in the approximation reaches its peak when the sum of the two mantissa values (ma and mb) equals 128. In other words, the mantissa values ma and mb are usually represented in floating-point format. In logarithmic-based multiplication approximation, error tends to increase as the magnitude of input values increases. If BF16 mantissas are assumed to be stored in 7-bit format, the maximum unsigned mantissa value would be 127 (i.e., 2⁷−1). When ma+mb=128, this means that the combined input magnitude is at a point where approximation introduces the largest error. For example, if the mantissa values are ma=64 and mb=64, then ma+mb=128. The approximate multiplication using a logarithmic transformation and addition may introduce the largest absolute error at this sum.

The second observation suggests that as the absolute difference between the two mantissa values increases, the approximation error also increases. In other words, in logarithmic multiplication, the logs of ma and mb are approximated, instead of performing exact multiplication. The accuracy of this transformation depends on the uniformity of the mantissa values. When ma and mb are close, the logarithm function between them is more linear, resulting in a lower error. When ma-mb is large, the interpolation error in the logarithmic approximations increases due to the greater variation in input values. For example, if ma=100 and mb=30, then ma−mb=70. However, if ma=70 and mb=64, then ma−mb=6. The absolute error in the first case is higher than the second case because the logarithmic transformation has to compensate for a large difference.

Given these two observations, an adjustment or adjust term 272 can be introduced to the 2^{(0.ma+0.mb)+adjust term} (270).

The adjust term 272 can be given as:

$$adjust term = ( 128 - abs ( ma + mb - 128 ) - abs ( mb - mb ) ) / 4.$$

In a practical application, the RTL implementation of config_m5 (using 1.ma*1.mb approximation and the adjust term 272) has about 209 gates. The original implementation (without approximations) has about 722 gates. The gate number reduction is thus 71% when using approximate mantissa multiplication.

The examples are not limited to any particular data type. The data types BF16 (or bfloat16) is presented for illustrative purposes only. Supporting all data types is beneficial for architectures handling diverse computational workloads. By handling mantissa approximations for any data type, the present architecture becomes versatile. This flexible approach allows the present architecture to handle various types of data without being constrained by a fixed data type or format.

Example AI applications benefiting from approximate mantissa multiplication and logarithm transformations include, e.g., deep learning inference on edge devices, large language models, computer visions for autonomous vehicles, reinforcement learning (RL) for robotics, and generative AI. Edge devices have limited power and computational resources, making full-precision multipliers (e.g., FP32) impractical. Approximate multipliers reduce power consumption and area while maintaining accuracy, enabling efficient low-power AI processing. Large language models use massive matrix multiplications (e.g., attention mechanisms), consuming significant energy and computational resources. Approximating mantissa multiplication using logarithmic transformations reduces the number of gates needed in hardware, allowing faster and more efficient tensor operations in GPUs and AI accelerators. AI vision models use extensive floating-point multiplications for feature extraction and classification. Reducing gate count for mantissa multiplication allows more parallelism in AI accelerators, leading to lower latency and energy-efficient computations. RL models need fast numerical computations for reward function updates and policy evaluations. Approximate logarithmic multiplication enables smaller, more efficient AI engines, making real-time decision-making faster and more power-efficient. High-precision multipliers consume excessive chip area and power, limiting the scalability of generative models. Approximate mantissa multipliers enable faster convolution operations, reducing inference time for models.

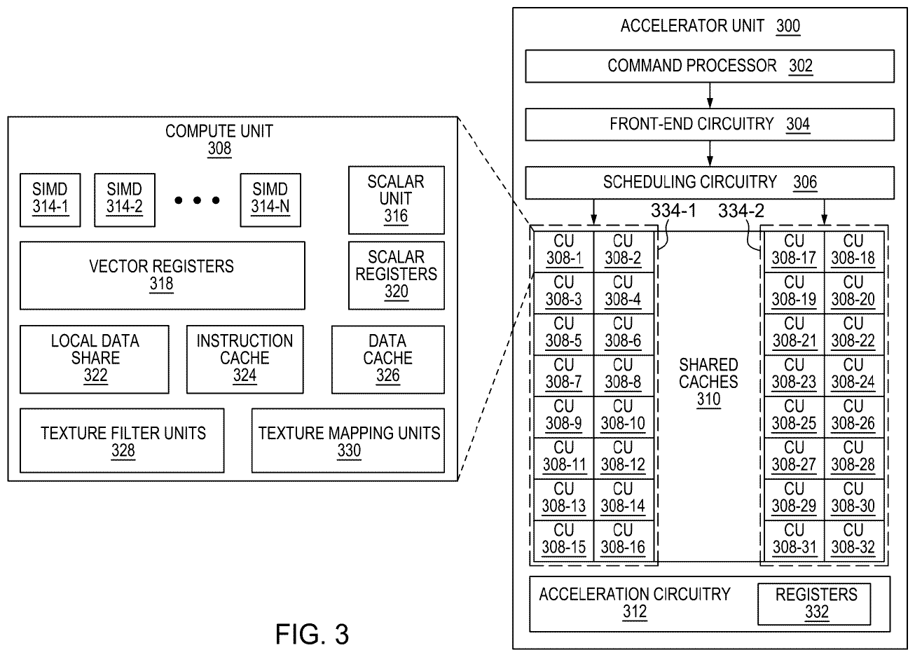

FIG. 3 is a block diagram of an accelerator unit (AU) configured to execute workloads for applications running on a processing system, in accordance with some examples.

FIG. 3 presents an AU 300 configured to execute workloads for one or more applications running on a processing system. These applications include, for example, compute applications, graphics applications, or both each configured to issue respective series of instructions, also referred to herein as “threads,” to a central processing unit (CPU) of the processing system. Compute applications, when executed by a processing system, cause the processing system to perform one or more computations, such as machine-learning, neural network, high-performance computing, or databasing computations. Further, graphics applications, when executed by a processing system, cause the processing system to render a scene including one or more graphics objects and, as an example, output the scene on a display. The instructions issued to the CPU from these applications, for example, include groups of threads, also referred to herein as “workgroups,” to be executed by AU 300. To perform these workgroups, AU 300 includes one or more vector processors, coprocessors, graphics processing units (GPUs), general-purpose GPUs, non-scalar processors, highly parallel processors, artificial intelligence (AI) processors, inference engines, AI engines, AI engine cores, machine-learning processors, or any combination thereof. As an example, AU 300 includes one or more command processors 302, front-end circuitry 304, scheduling circuitry 306, compute units 308, shared caches 310, and acceleration circuitry 312.

A command processor 302 of AU 300 is configured to receive, from the CPU, a command stream indicating one or more workgroups to be executed. As an example, based on a compute application running on the processing system, the command processor 302 receives a command stream indicating workgroups that involve compute operations such as matrix multiplication, addition, subtraction, and the like to be performed. As another example, based on a graphics application running on the processing system, the command processor 302 receives a command stream indicating workgroups that include draw calls for a scene to be rendered. After receiving a command stream, the command processor 302 parses the command stream and issues respective instructions of the indicated workgroups to front-end circuitry 304, scheduling circuitry 306, or both. As an example, based on a command stream from a graphics application, the command processor 302 issues one or more draw calls to front-end circuitry 304 that includes one or more vertex shaders, polygon list builders, and the like. From the instructions issued from the command processor 302, front-end circuitry 304 is configured to position geometry objects in a scene, assemble primitives in a scene, cull primitives, perform visibility passes for primitives in a scene, generate visible primitive lists for a scene, or any combination thereof. For example, based on a set of draw calls received from a command processor 302, front-end circuitry 304 determines a list of primitives to be rendered for a scene. After determining a list of primitives to be rendered for a scene, the front-end circuitry 304 issues one or more draw calls (e.g., a workgroup) associated with the primitives in the list of primitives to scheduling circuitry 306.

Based on the instructions of the workgroups received from a command processor 302, front-end circuitry 304, or both, scheduler circuitry 306 is configured to provide data indicating threads (e.g., operations for these threads) to be executed for these workgroups to one or more compute units 308. Each compute unit 308 is configured to support the concurrent execution of two or more threads of a workgroup. For example, each compute unit 308 is configured to concurrently execute a predetermined number of threads referred to herein as a “wavefront.” Based on the size of the wavefront of a compute unit 308, scheduler circuitry 306 schedules one or more groups of threads of the workgroup, also referred to herein as “waves,” to be executed by the compute unit 308. As an example, scheduler circuitry 306 first updates one or more registers of a compute unit 308 such that the compute unit 308 is configured to execute a first group of waves of the workgroup. After the compute unit 308 has executed the first group of waves, scheduler circuitry 306 updates one or more registers of the compute unit 308 to schedule a second group of waves of the workgroup to be executed by the compute unit 308. To execute these waves, each compute unit is connected to one or more shared caches 310 that each include a volatile memory, non-volatile memory, or both accessible by one or more compute units 308. These shared caches 310, for example, are configured to store data (e.g., register files, values, operands, instructions, variables) used in the execution of one or more waves, data resulting from the performance of one or more waves, or both. Because a shared cache 310 is accessible by two or more compute units 308, a first compute unit 308 is enabled to provide results from the execution of a first wave to a second compute unit 308 executing a second wave. Though the examples presented in FIG. 3 shows AU 300 as including 32 compute units (308-1 to 308-32), in other implementations, AU 300 can include any number of compute units 308.

Each compute unit 308 includes one or more single instruction, multiple data (SIMD) units 314, a scalar unit 316, vector registers 318, scalar registers 320, local data share 322, instruction cache 324, data cache 326, texture filter units 328, texture mapping units 330, or any combination thereof. A SIMD unit 314 (e.g., a vector processor) is configured to concurrently perform multiple instances of the same operation for a wave. For example, a SIMD unit 314 includes two or more lanes each including an arithmetic logic unit (ALU) and each configured to perform the same operation for the threads of a wave. Though the examples presented in FIG. 3 shows a compute unit 308 including three SIMD units (314-1, 314-2, 314-N) representing an N number of SIMD units, in other implementations, a compute unit 308 can include any number of SIMD units 314. Further, as an example, the size of a wavefront supported by AU 300 is based on the number of SIMD units 314 included in each compute unit 308. To determine the operations performed by the SIMD units 314, each compute unit 308 includes vector registers 318 formed from one or more physical registers of AU 300. These vector registers 318 are configured to store data (e.g., operands, values) used by the respective lanes of the SIMD units 314 to perform a corresponding operation for the wave. Additionally, each compute unit 308 includes a scalar unit 316 configured to perform scalar operations for the wave. As an example, the scalar unit 316 includes an ALU configured to perform scalar operations. To support the scalar unit 316, each compute unit 308 includes scalar registers 320 formed from one or more physical registers of accelerator unit 300. These scalar registers 320 store data (e.g., operands, values) used by the scalar unit 316 to perform a corresponding scalar operation for the wave.

Further, each compute unit 308 includes a local data share 322 formed from a volatile memory (e.g., random-access memory) accessible by each SIMD unit 314 and the scalar unit 316 of the compute unit 308. That is to say, the local data share 322 is shared across each wave concurrently executing on the compute unit 308. The local data share 322 is configured to store data resulting from the execution of one or more operations for one or more waves, data (e.g., register files, values, operands, instructions, variables) used in the execution of one or operations for one or more waves, or both. As an example, the local data share 322 is used as a scratch memory to store results necessary for, aiding in, or helpful for the performance of one or more operations by one or more SIMD units 314. The instruction cache 324 of a compute unit 308, for example, includes a volatile memory, non-volatile memory, or both configured to store the instructions to be executed for one or more waves to be executed by the compute unit 308. Further, the data cache 326 of a compute unit 308 includes a volatile memory, non-volatile memory, or both configured to store data (e.g., register files, values, operands, variables) used in the execution of one or more waves by the compute unit 308. The instruction cache 324, data cache 326, shared caches 310, and a system memory, for example, are arranged in a hierarchy based on the respective sizes of the caches. As an example, based on such a cache hierarchy, a compute unit 308 first requests data from a controller of a corresponding data cache 326. Based on the data not being in the data cache 326, the data cache 326 requests the data from a shared cache 310 at the next level of the cache hierarchy. The caches then continue in this way until the data is found in a cache or requested from the system memory, at which point, the data is returned to the compute unit 308. Additionally, each compute unit 308 includes one or more texture mapping units 330 each including circuitry configured to map textures to one or more graphics objects (e.g., groups of primitives) generated by the compute units 308. Further, each compute unit 308 includes one or more texture filter units 328 each having circuitry configured to filter the textures applied to the generated graphics objects. For example, the texture filter units 328 are configured to perform one or more magnification operations, anti-aliasing operations, or both to filter a texture.

Additionally, to help perform instructions for one or more workgroups, AU 300 includes acceleration circuitry 312. Such acceleration circuitry 312 includes hardware (e.g., fixed-function hardware) configured to execute one or more instructions for one or more workgroups. As an example, acceleration circuitry 312 includes one or more instances of fixed function hardware configured to encode frames, encode audio, decode frames, decode audio, display frames, output audio, perform matrix multiplication, or any combination thereof. To schedule instructions for execution on such hardware, scheduling circuitry 306 is configured to update one or more physical registers 332 of AU 300 associated with the hardware. In some cases, AU 300 includes one or more compute units 308 grouped into one or more shader engines 334. Referring to the implementation presented in FIG. 3, for example, AU 300 includes compute units 308-1 to 308-16 grouped in a first shader engine 334-1 and compute units 308-17 to 308-32 grouped in a second shader engine 334-2. Such shader engines 334, for example, are configured to execute one or more workgroups (e.g., one or more compute kernels) for an application and include one or more compute units 308, graphics processing hardware (e.g., primitive assemblers, rasterizers), one or more shared caches 310, render backends, or any combination thereof. Though the example presented in FIG. 3 shows AU 300 as including two shader engines (334-1, 334-2), in other implementations, AU 300 can include any number of shader engines (334-1, 334-2).

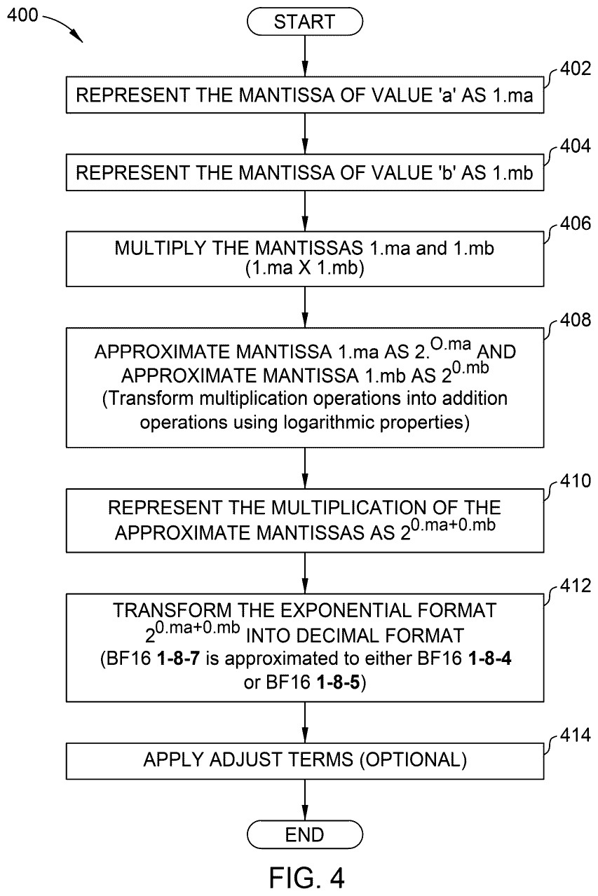

FIG. 4 illustrates a method for implementing a multiplier that supports a mantissa multiplication using approximate mantissa values, according to an example.

At 402, the mantissa of value ‘a’ is represented as 1.ma. The first part is the implicit leading 1 in the floating point definition and the second part represents the mantissa field of the floating-point number.

At 404, the mantissa of value ‘b’ is represented as 1.mb. The first part is the implicit leading 1 in the floating point definition and the second part represents the mantissa field of the floating-point number.

At 406, the mantissas 1.ma and 1.mb are multiplied (1.ma×1.mb).

At 408, mantissa 1.ma is approximated as 2^{(0.ma)} and mantissa 1.mb is approximated as 2^{(0.mb)}. Multiplication operations are transformed into addition operations using logarithmic properties. Thus, the mantissa multiplication is given as (1.ma) multiplied by (1.mb), which can be approximated to 2^{(0.ma)+2(0.mb)}.

At 410, the multiplication of the approximate mantissas is represented as 2^{(0.ma+0.mb)}.

At 412, the exponential format 2^{(0.ma+0.mb)} is transformed into decimal format, where the BF16 1-8-7 is approximated to either BF16 1-8-4 or BF16 1-8-5. The method can save area without significantly impacting accuracy, as the accuracy after approximation is at the same level of 1-8-4/1-8-5 mantissa multiplication.

At 414, adjust terms may be applied. The adjust terms help reduce the absolute error. The adjust terms can prevent distortions and stabilize the logarithmic transformation.

Optimizing the mantissa multiplication in BF16 format by reducing its area provides several benefits, particularly for AI accelerators, GPUs, and deep learning workloads. Since multipliers consume a significant portion of silicon area and power, reducing their size improves overall efficiency while maintaining computational performance. The benefits of this approach include at least chip area savings, power efficiency, higher computational density, and cost reduction.

By simplifying the BF16 mantissa multiplier, fewer transistors are used, leading to a smaller footprint per multiplication unit. This enables chip designers to fit more processing elements within the same silicon area, increasing parallelism in AI accelerators. More processing cores translate to higher throughput for deep learning workloads, making AI chips more efficient in handling massive matrix multiplications. For example, if an AI accelerator initially dedicates 30% of its area to multipliers, a 25% reduction in mantissa multiplier size could free up a substantial portion of silicon for additional tensor cores, memory buffers, or specialized AI logic. This approach can be beneficial for cloud AI servers and edge AI devices, where maximizing compute resources within a constrained chip area is beneficial.

Multiplication is one of the most power-hungry operations in AI hardware. By reducing mantissa multiplication complexity, fewer transistors switch per operation, leading to lower dynamic power consumption. This results in improved energy efficiency, which is beneficial for both datacenter AI workloads (where energy costs are significant) and low-power AI applications (such as mobile devices and Internet-of-Things (IoT)). Lower power consumption also leads to reduced heat generation, minimizing the need for aggressive cooling solutions. This allows AI chips to operate at higher clock speeds or be deployed in fan-less environments, making AI acceleration feasible for edge computing and embedded systems without active cooling.

Since multipliers occupy a large portion of chip area, reducing their size leads to smaller die sizes, improving manufacturing yield and reducing production costs. A smaller die means more chips per wafer, reducing the per-unit cost of AI accelerators. For instance, wafer costs are high, and any reduction in chip size translates to significant savings. If the multiplier area is reduced by 20-30%, overall chip production costs could drop proportionally, making AI chips more affordable and accessible. This is beneficial for mass-market AI applications, including smartphones, autonomous vehicles, and consumer AI devices.

Therefore, optimizing BF16 mantissa multiplication offers a balance between efficiency, performance, and cost. By reducing multiplier size, AI chips can achieve higher computational density, lower power consumption, and better cost efficiency without significantly impacting model accuracy. These optimizations are beneficial for scalable AI hardware, ensuring that future AI accelerators can handle increasingly complex workloads while remaining power-efficient and cost-effective.

In conclusion, transforming multiplication operations into addition operations using logarithmic properties offers a promising solution to reducing the complexity and resource demands of AI hardware. By approximating the mantissa multiplication, particularly in floating-point representations like BF16, the gate count needed for these operations can be significantly reduced. Traditional mantissa multiplication, with its reliance on 1-8-7 bit representations, involves complex and costly hardware implementations. However, by approximating the mantissa to formats like 1-8-4 or 1-8-5, a more efficient multiplier can be created.

The benefit of approximating the mantissa lies not only in reducing the gate count but also in improving the overall efficiency of the chip. AI chips, which usually perform extensive multiplication operations for tasks like matrix multiplication and deep learning model training, can benefit from this optimization by achieving faster computations with reduced area and power consumption. By adopting logarithmic transformations, where multiplication operations are replaced with addition, the same results can be achieved with lower hardware cost, leading to more power-efficient designs without sacrificing the performance needed for most AI workloads.

This approach also opens up new possibilities in designing approximate multipliers. By adopting simpler multipliers, such as those with 1-8-4 or 1-8-5 bit mantissas, hardware designers can achieve a balance between accuracy and efficiency. The tradeoff between precision and hardware resources is a common challenge in AI chip design, and logarithmic transformations offer a practical way to make this tradeoff more manageable, enabling higher throughput while reducing the physical footprint of the multiplier circuits.

Ultimately, this technique of transforming multiplication into addition using logarithmic properties and approximate mantissas can improve AI chip design by making it more scalable and cost-effective. As AI workloads continue to demand more computational power, these kinds of optimizations will become increasingly valuable. The ability to simplify the hardware (with approximate mantissa multiplication multipliers) without significantly impacting the quality of results ensures that AI hardware will continue to evolve toward more efficient and affordable solutions, ready to meet the growing demands of advanced AI applications.

In the preceding, reference is made to embodiments presented in this disclosure. However, the scope of the present disclosure is not limited to specific described embodiments. Instead, any combination of the described features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

As will be appreciated by one skilled in the art, the embodiments disclosed herein may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium is any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various examples of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to specific examples, other and further examples may be devised without departing from the basic scope thereof, and the scope thereof is determined by the claims that follow.

What is claimed is:

1. An artificial intelligence (AI) engine comprising:
a logic circuit; and
a multiplier configured to support mantissa multiplication using approximate mantissa values and logarithmic transformations.

2. The AI engine of claim 1, wherein the mantissa multiplication is configured to be performed for a floating-point data type.

3. The AI engine of claim 1, wherein the logic circuit approximates the mantissa values using reduced precision multiplication.

4. The AI engine of claim 1, wherein each of the approximate mantissa values is represented having a first part being a leading 1 in a floating point format and a second part being a mantissa field of a floating-point number.

5. The AI engine of claim 1, wherein the logic circuit is configured to convert the mantissa values into a logarithmic domain where the mantissa multiplication is transformed to an addition operation.

6. The AI engine of claim 1, wherein the logarithmic transformations approximate a logarithm of the mantissa values, and wherein the multiplier is configured to:
perform a logarithmic addition operation of the approximated logarithm of the mantissa values of two or more input values, and
use an approximate exponentiation function to obtain an approximate mantissa value result as an estimate of a product of the two or more input values.

7. The AI engine of claim 6, wherein the multiplier is further configured to adjust an absolute error that is a difference between an exact result of the mantissa multiplication and the approximated mantissa value result due to performing the logarithmic addition operation, wherein adjusting the absolute error comprises applying an adjustment term to the logarithmic addition operation.

8. The AI engine of claim 1, wherein the multiplier is configured to:
receive matrix and vector data for machine learning (ML) inference;
transform the matrix and vector data by converting matrix and vector elements into logarithmic values;
perform multiplication in a logarithmic domain using addition-based operations; and
generate an output corresponding to an approximated product of matrix-matrix or matrix-vector multiplications, wherein the output is used for further ML inference computations.

9. A processor comprising:
one or more artificial intelligence (AI) engines, each AI engine including:
a multiplier configured to support mantissa multiplication using approximate mantissa values and logarithmic transformations.

10. The processor of claim 9, wherein the processor is a graphics processing unit (GPU).

11. The processor of claim 9, wherein the mantissa multiplication is configured to be performed for a floating-point data type.

12. The processor of claim 9, wherein each of the approximate mantissa values is represented having a first part being a leading 1 in a floating point format and a second part being a mantissa field of a floating-point number.

13. The processor of claim 9, wherein the logarithmic transformations approximate a logarithm of the mantissa values, perform a logarithmic addition operation, and use an approximate exponentiation function to obtain an approximate mantissa value result.

14. The processor of claim 13, wherein the multiplier is further configured to adjust an absolute error that is a difference between an exact result of the mantissa multiplication and the approximated mantissa value result due to performing the logarithmic addition operation, wherein adjusting the absolute error comprises applying an adjustment term to the logarithmic addition operation.

15. The processor of claim 9, wherein the multiplier is configured to:
receive matrix and vector data for machine learning (ML) inference;
transform the matrix and vector data by converting matrix and vector elements into logarithmic values;
perform multiplication in a logarithmic domain using addition-based operations; and
generate an output corresponding to an approximated product of matrix-matrix or matrix-vector multiplications, wherein the output is used for further ML inference computations.

16. A method comprising:
using, by a multiplier, approximate mantissa values to support mantissa multiplication; and
applying logarithmic transformations to convert the mantissa multiplication to a logarithmic addition operation.

17. The method of claim 16, wherein the mantissa multiplication is configured to be performed for a floating-point data type.

18. The method of claim 16, wherein the logarithmic transformations approximate a logarithm of the mantissa values, perform the logarithmic addition operation, and use an approximate exponentiation function to obtain an approximate mantissa value result.

19. The method of claim 16, further comprising:
adjusting an absolute error that is a difference between an exact result of the mantissa multiplication and the approximated mantissa value result due to performing the logarithmic addition operation, wherein adjusting the absolute error comprises applying an adjustment term to the logarithmic addition operation.

20. The method of claim 16, further comprising using the multiplier to:
receive matrix and vector data for machine learning (ML) inference;
transform the matrix and vector data by converting matrix and vector elements into logarithmic values;
perform multiplication in a logarithmic domain using addition-based operations; and
generate an output corresponding to an approximated product of matrix-matrix or matrix-vector multiplications, wherein the output is used for further ML inference computations.
